(19) United States
(12) Patent Application Publication
(10) Pub. No.: US 2011/0313994 A1
(43) Pub. Date: Dec. 22, 2011

(54) CONTENT PERSONALIZATION BASED ON USER INFORMATION

(75) Inventors: Roy Varshavsky, Tel Aviv (IL); Kfir Karmon, Petach-Tikva (IL); Daniel Sitton, Tel Aviv (IL); Limor Lahiani, Tel Aviv (IL); David Heckerman, Santa Monica, CA (US); Robert Davidson, Kirkland, WA (US)

(73) Assignee: Microsoft Corporation, Redmond, WA (US)

(21) Appl. No.: 12/818,919

(22) Filed: Jun. 18, 2010

(51) Int. Cl. G06F 17/30

(52) U.S. Cl. 707/707; 707/770; 707/765; 707/E17.108; 707/E17.014; 707/E17.074

(57) ABSTRACT

A particular method of content personalization based on user information includes receiving data representing an information retrieval task. The data is received at a server from a computing device associated with a user. The information retrieval task is executed to generate result information. Personalization information associated with the user that is relevant to the information retrieval task is retrieved. The personalization information associated with the user includes information associated with at least one of a genotype of the user and a phenotype of the user. The method includes modifying the result information based on the retrieved personalization information to generate personalized result information. The personalized result information is transmitted to the computing device associated with the user

### BACKGROUND

The amount of information available via the Internet is increasing, and due to this “information overload” it may be difficult to find and extract relevant information. Internet search engines are commonly used by users to attempt to locate relevant information on a particular topic. Typically, a search engine accepts a search request and returns “hits,” i.e., identifies search results such as web pages that the search engine has determined to be relevant to the search request. This list of search results is often thousands of entries long, making it difficult for the user to find search results that are specifically relevant to the user.

### SUMMARY

Systems and methods of content personalization are disclosed. For example, content personalization may occur before, during, or after performance of an information retrieval task, such as an Internet search. With respect to client-server architectures, content personalization may occur at the client, at the server, or at both the client and the server. Content personalization may also occur at an offline system (e.g., during a local search or archival task).

Content personalization may be especially useful during information retrieval tasks such as medical information searches. For example, it is not uncommon for a user to research a particular ailment on the Internet in response to learning that they or a family member is afflicted with the particular ailment. Content personalization may occur one or more times during an information retrieval process. To illustrate, a user may enter a search query (e.g., a medical search query) and personalization information associated with the user (e.g., information regarding the user's genotypes, phenotypes, medical history, behavioral history, etc.) may be used to modify the search query before the search query is submitted to a search engine. The modified search query may return more relevant results than the original search query. As another example, a user may enter a search query and a search engine may generate search results based on the search query. Personalization information associated with the user may be used to mine the search results for result items of higher relevance to the user, and the more relevant result items may be emphasized (e.g., via filtering, ordering, highlighting, etc.) when the search results are displayed to the user. Identifying relevant personalization information may include finding patterns (e.g., data matches) in user information and data retrieved from an information repository. For example, when a user performs a search for “Asthma,” information retrieved from a medical database may include a list of gene mutations associated with Asthma. When the user's genotype/phenotype information matches a particular mutation in the list, the genotype/phenotype information may be used to extend the search query or modify the search results.

Although content personalization is largely described with respect to search tasks and medical data, the systems and techniques disclosed herein may be used with any information retrieval task to generate more relevant personalized results for a particular user or group.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a diagram of a particular embodiment of a system of content personalization based on user medical information;

FIG. 2 is a diagram of another particular embodiment of a system of content personalization based on user medical information;

FIG. 3 is a diagram of a particular embodiment of the information repository of FIGS. 1-2;

FIG. 4 is a flow diagram of a particular embodiment of a method of content personalization based on user medical information;

FIG. 5 is a flow diagram of another particular embodiment of a method of content personalization based on user medical information; and

FIG. 6 is a block diagram of a computing environment including a computing device operable to support embodiments of computer-implemented methods, computer program products, and system components as illustrated in FIGS. 1-5.

### DETAILED DESCRIPTION

In a particular embodiment, a method includes receiving data representing an information retrieval task. The data is received at a server from a computing device associated with a user. The method includes executing the information retrieval task to generate result information. The method further includes retrieving personalization information associated with the user that is relevant to the information retrieval task. The personalization information associated with the user includes information associated with at least one of a genotype of the user and a phenotype of the user. The method includes modifying the result information based on the retrieved personalization information to generate personalized result information. The method also includes transmitting the personalized result information to the computing device associated with the user.

In another particular embodiment, a computer-readable medium includes instructions that, when executed by a computer, cause the computer to receive a search query at a computing device associated with a user. The instructions also cause the computer to retrieve medical information associated with the user that is relevant to the search query. The medical information includes information associated with at least one of a genotype of the user and a phenotype of the user. The instructions further cause the computer to extend the search query based on the retrieved medical information to generate an extended search query. The instructions cause the computer to transmit the extended search query to a second computing device.

In another particular embodiment, a system includes a processor and a relevant information identification module executable by the processor to retrieve data from a medical information repository based on at least one medical search term of a search query. The relevant information identification module is also executable to compare the data retrieved from the medical information repository to personal information associated with the user to identify medical information associated with the user that is relevant to the search query. The medical information includes information associated with at least one of a genotype of the user and a phenotype of the user. The system also includes a query extension module executable by the processor to extend the search query to generate an extended search query. The system further includes a result modification module executable by the processor to modify search results based on the identified medical information to generate modified search results.

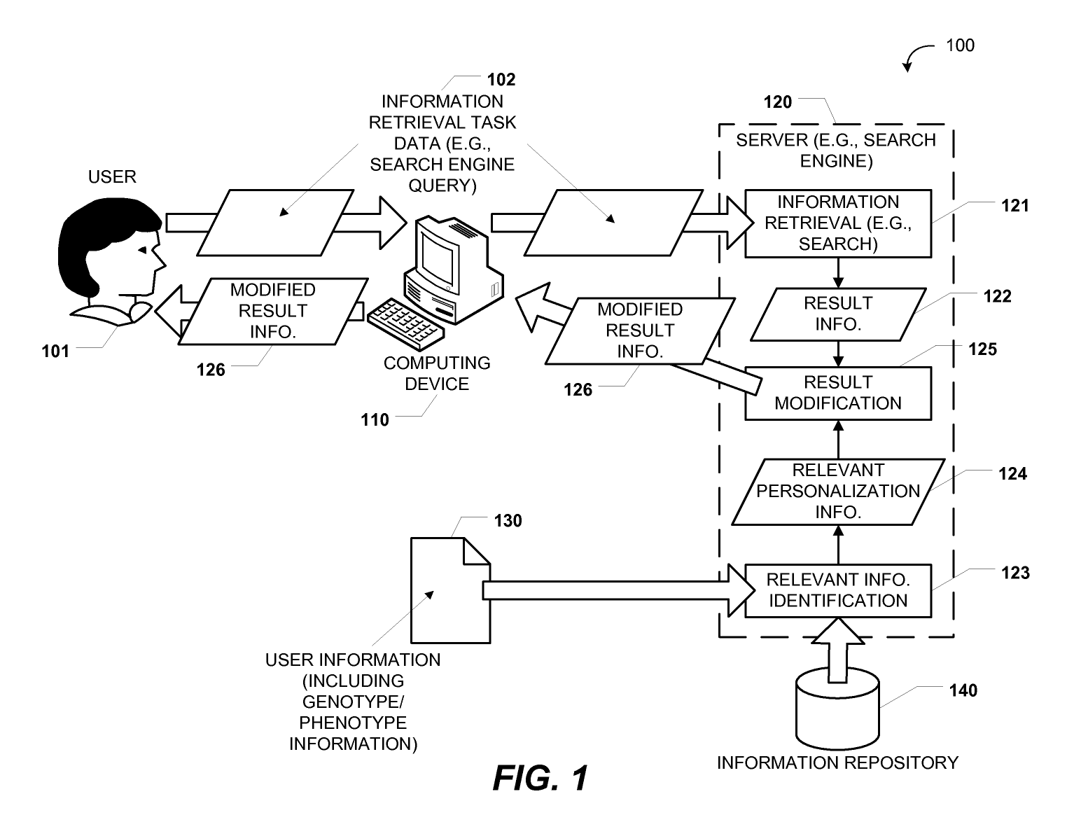

FIG. 1 is a diagram of a particular embodiment of a system of content personalization based on user medical information and is generally designated 100. The system 100 includes a computing device 110 that is associated with a user 101 and that is communicatively coupled to a server 120 (e.g., via a network such as the Internet).

The computing device 110 may be a desktop computer, a laptop computer, a server, a mobile phone, or other device configured to receive data 102 from the user 101, where the data 102 represents an information retrieval task. For example, the data 102 may represent a user-initiated search engine query and may include one or more search terms (e.g., “Asthma”). The computing device 110 may also be configured to transmit the data 102 to a server 120. For example, the server 120 may be associated with an Internet search engine.

The server 120 may include an information retrieval module 121 configured to execute an information retrieval task to generate result information 122. For example, when the data 102 represents a search engine query, the information retrieval module 121 may query a search engine based on the search engine query to generate the result information 122 (e.g., a list of search results for “Asthma”). The result information 122 may include textual information, video information, audio information, graphic information, or any combination thereof.

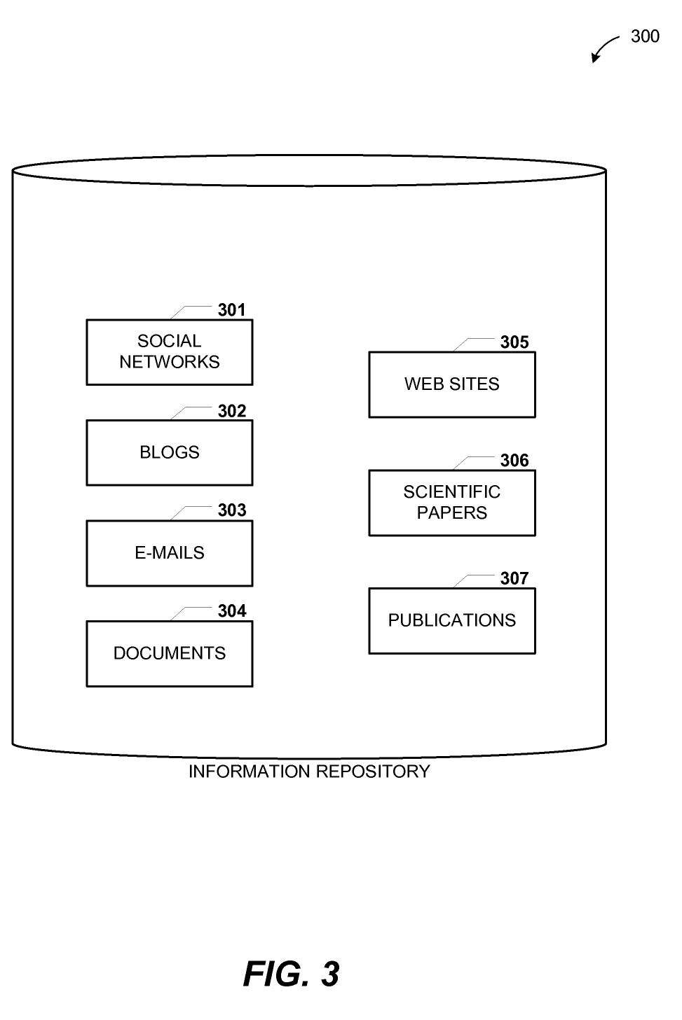

The server 120 may also include a relevant information identification module 123. The relevant information identification module 123 may be coupled to an information repository 140 to identify patterns associated with search queries. For example, the relevant information identification module 123 may retrieve data based on a search term (e.g., “Asthma”) from the information repository 140. For example, the retrieved data may include medical research indicating that the ailment asthma may be caused by environmental risk factors, such as secondhand smoke and high pollution levels, medical history items, such as caesarean sections and early childhood antibiotic use, and mutations in genes, such as a disintegrin and metalloproteinase domain-containing 33 (ADAM33) gene. Examples of content included in or accessible to the information repository 140 are further described and illustrated with reference to FIG. 3.

The relevant information module 123 may mine user information 130 associated with the user 101 and identify personalization information (e.g., portions of the user information 130) that is relevant to a particular information retrieval task. The user information 130 may be stored at the server 120. Alternately, the user information 130 may be retrieved from the computing device 110 or from a second server that is remote to the server 120 (e.g., a hospital server or a user medical information database). When the user information 130 is stored at a device other than the server 120, the user information 130 may be retrieved via a network (e.g., a local area network (LAN), wide area network (WAN), or the Internet). In a particular embodiment, the user information 130 is stored and retrieved securely (e.g., to protect privacy of the user 101). For example, the user information 130, or portions thereof, may be stored and transmitted as an encrypted file that is decrypted at the server 120. As another example, the user 101 may provide the server 120 with authentication and authorization data (e.g., a login and password) to enable the server 120 to access the user information 130.

The user information 130 may be represented as computer-readable data (e.g., one or more computer files) and may include genotype information of the user 101 (e.g., specific gene listings and portions of the user's genome), phenotype information of the user 101 (e.g., specific traits of the user caused by particular genotypes), behavioral information of the user, physical conditions of the user 101 (e.g., medial symptoms), a medical history of the user 101, or any combination thereof. For example, the user information 130 may include a sequence listing of the user's ADAM33 gene. The relevant information identification module 123 may determine a match between the user's ADAM33 gene and data retrieved from the information repository regarding the ADAM33 mutation that potentially causes asthma. The relevant information identification module 123 may generate relevant personalization information 124 indicating that the user 101 is likely to have a genetic form of asthma caused by a mutation in the ADAM33 gene. In a particular embodiment, personal information such as genotype and phenotype information is made available to the user 101 by a medical care provider, identification agency, or other organization after analyzing blood/tissue samples provided by the user 101. For example, genotype information, phenotype information, behavioral information, physical condition information, and medical history information may be stored as part of an electronic medical record of the user 101 that is accessible to the user 101 and to other parties that are authorized by the user 101. Alternately, the user 101 may access and analyze his or her personal genome to produce genotype and phenotype information.

The server 120 may further include a result modification module 125 configured to modify the result information 122 based on the relevant personalization information 124 to generate modified result information 126. For example, the result modification module 125 may modify the list of search results for “Asthma” based on the relevant personalization information 124 (e.g., “ADAM33”). Modifying the result information may include filtering the result information 122 (e.g., removing result items that are not relevant to ADAM33-based asthma), ordering the result information 122 (e.g., such that result items relevant to ADAM33-based asthma are at the top of the list), highlighting portions of the result information 122 (e.g., highlighting result items that are relevant to ADAM33-based asthma), or any combination thereof. The modified result information 126 may be transmitted by the server 120 to the computing device 110 for display to the user 101 (e.g., via a display device).

In operation, the server 120 may receive the data 102 representing an information retrieval task from the computing device 110 associated with the user 101. The information retrieval module 121 may execute the information retrieval task based on the data 102 to generate the result information 122. For example, the data 102 may represent a search query and the information retrieval module 121 may perform a search based on the search query to generate search results. The relevant information identification module 123 may identify matches between the user information 130 associated with the user 101 and data retrieved from the information repository 140 to identify the relevant personalization information 124. The result modification module 125 may modify the result information (e.g., via filtering, ordering, and/or highlighting) based on the relevant personalization information 124 to generate modified result information 126 that is personalized for the user 101 and may be more relevant to the user 101 than the result information 122. The modified result information 126 may be transmitted to the computing device 110 (e.g., for display to the user 101).

It should be noted that although the particular embodiment illustrated in FIG. 1 depicts server-side result modification, result modification may also be performed at client devices. For example, in an alternate embodiment, the server 120 may transmit the result information 122 to the computing device 110 and the computing device 110 may identify the relevant personalization information 124 and may generate the modified result information 126. Content personalization may also be performed at a standalone information retrieval system (e.g., a local search at an offline computing device or a library/archive browser).

Further, it should be noted that content personalization as disclosed herein may be performed with respect to tasks other than search. For example, the server 120 may be associated with a hospital or clinic website, and the user 101 may be accessing the server 120 to discuss the user's asthmatic condition with a physician via an online chat or audio/video conference. The hospital may employ multiple physicians who are knowledgeable about asthma, including allergists, internists, pediatricians, ear-nose-throat (ENT) specialists, and pulmonologists. The information retrieval task performed by the server 120 may include identifying all physicians employed by the hospital that are knowledgeable about asthma and determining which particular physician to pair the user 101 with. In such an embodiment, the relevant personalization information 124 may be used to pair the user 101 with a particular physician that specializes in treating ADAM33-based asthma. The relevant personalization information 124 may also be used to determine personalized treatment options and medicines for the user 101.

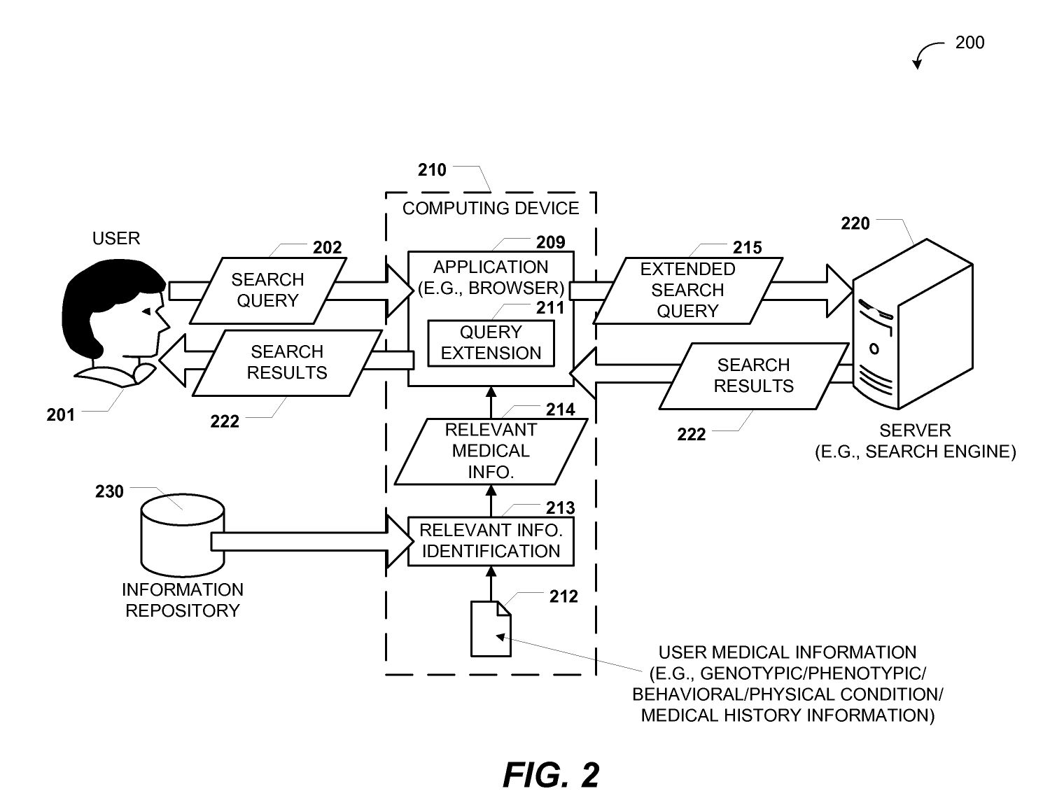

FIG. 2 is a diagram of another particular embodiment of a system of content personalization based on user medical information and is generally designated 200. The system 200 includes a computing device 210 that is associated with a user 201 and that is communicatively coupled to a server 220 (e.g., via a network such as the Internet). In an illustrative embodiment, the computing device 210 is the computing device 110 of FIG. 1 and the server 220 is the server 120 of FIG. 1.

The computing device 210 may be configured to receive search queries from users (e.g., an illustrative search query 202 from a user 201). In an illustrative embodiment, the search query 202 is received at an application 209 executing on the computing device 210. For example, the application 209 may include a web browser, a social networking application, a library application, an archival application, or any combination thereof.

In a particular embodiment, the application 209 includes a query extension module 211 configured to extend the search query 202 based on relevant medical information 214 associated with the user 201. For example, a relevant information identification module 213 at the computing device 212 may find patterns in user medical information 212 and data retrieved from an information repository 230, as described and illustrated with reference to the relevant information identification module 123 of FIG. 1. When the search query 202 is “Asthma” and the user medical information 212 indicates that the user 201 has a particular mutation in the ADAM33 gene, the relevant medical information 214 may include the term “ADAM33” as a suggested search term to add to the original search query 202 “Asthma.” The query extension module 211 may extend the search query 202 based on the relevant medical information 214 to generate an extended search query 215 “Asthma+ADAM33.”

The computing device 210 may transmit search queries (e.g., the extended search query 215) to the server 220. The computing device 210 may also receive search results (e.g., illustrative search results 222) from the server 220. In a particular embodiment, the computing device 210 may display the received search results 222 to the user 201 via a display device.

In a particular embodiment, the extended search query 215 is automatically transmitted to the server 220 without input or intervention from the user 201. Alternately, the extended search query 215 may be transmitted to a display device for display to the user 201. For example, the extended search query 215 may be displayed as a “suggested personalized search query” at the application 209. The user 201 may thus be provided with a choice whether to query a search engine based on the original query “Asthma” or the personalized extended search query “Asthma+ADAM33.” The extended search query 215 may be transmitted to the server in response to receiving user input from the user 201 indicating a selection of the extended search query 215. In a particular embodiment, an explanation may also be displayed with a suggested search query. For example, the explanation may include that researchers have found that asthma may be caused by a mutation in the ADAM33 gene and that the user medical information 212 indicates that the user 201 has the ADAM33 gene mutation.

The server 220 may be a search engine server that generates search results based on received search queries. For example, the extended search query 215 may be transmitted to the server 220 (e.g., a search engine server), and the server 220 may return search results 222 based on the extended search query 215.

It will be appreciated that the systems 100 and 200 of FIGS. 1-2 may provide personalized and relevant information results. For example, results may be personalized after an initial search is conducted, as illustrated and described with reference to the result modification module 125 of FIG. 1. As another example, search queries may be personalized (e.g., extended) before a search is conducted, as illustrated and described with reference to the query extension module 211 of FIG. 2. The systems 100 and 200 of FIGS. 1-2 may thus enable more accurate personalized information retrieval.

In a particular embodiment, search results produced by pre-search query extension are similar to or the same as search results produced by post-search result modification. It will thus be appreciated that software developers may be free to implement the content personalization techniques disclosed herein on client devices or on server devices depending on various factors, such as bandwidth usage and processor utilization.

In another particular embodiment, content personalization may be implemented at a standalone device. In such an embodiment, the device may include pre-search query extension capability (e.g., as described and illustrated with reference to the query extension module 211 of FIG. 2) as well as post-search result modification capability (e.g., as described and illustrated with reference to the result modification module 125 of FIG. 1).

FIG. 3 is a diagram of a particular embodiment of an information repository 300. In an illustrative embodiment, the information repository 300 is the information repository 140 of FIG. 1 or the information repository 230 of FIG. 2.

The information repository 300 may include (e.g., as data stored on one or more data storage devices) or have access to (e.g., via the Internet) multiple types of data sources. The data sources may include user-generated data sources as well as third-party generated “authored” data sources. In a particular embodiment, the information repository is implemented as a server, a database, network attached storage (NAS), a clustered computing system, or any combination thereof.

User-generated data sources in the information repository 300 may include one or more social networks 301 that a user is a member of User-generated data sources may also include web logs (a.k.a. blogs) written by or read by the user. Communication records of the users, such as e-mails 303, and personal documents 304 of the user may also be included in the information repository 300.

“Authored” data sources may include web sites 305. For example, the information repository 300 may include or have access to general-purpose and specialized online encyclopedias. The “authored” data sources may also include scientific papers 306 (e.g., as part of a scientific paper repository) and publications 307, such as peer-reviewed journals (e.g., as part of a publication repository).

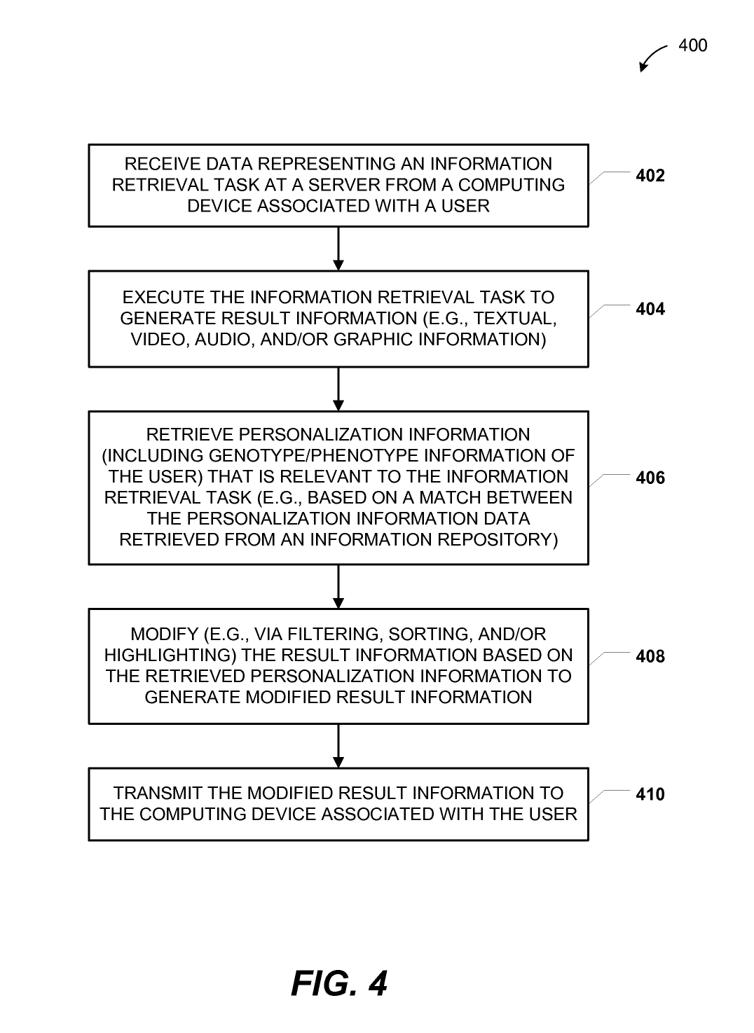

FIG. 4 is a flow diagram of a particular embodiment of a method 400 of content personalization based on user medical information. In an illustrative embodiment, the method 400 may be performed at the system 100 of FIG. 1.

The method 400 includes receiving data representing an information retrieval task, at 402. The data is received at a server from a computing device associated with a user. For example, in FIG. 1, the server 120 may receive the data 102 from the computing device 110 associated with the user 101.

The method 400 also includes executing the information retrieval task to generate result information, at 404. The result information may include textual, video, audio, and/or graphic information. For example, in FIG. 1, the information retrieval module 121 may generate the result information 122.

The method 400 further includes retrieving personalization information that is relevant to the information retrieval task, at 406. The personalization information may include genotype/phenotype information of the user and may be identified based on a match between the personalization information data retrieved from an information repository. For example, in FIG. 1, the relevant information identification module 123 may identify and retrieve the relevant personalization information 124 based on a match between the user information 130 and data from the information repository 140.

The method 400 includes modifying the result information based on the retrieved personalization information to generate modified result information, at 408. Modifying the result information may include filtering, sorting, and/or highlighting the result information. For example, in FIG. 1, the result modification module 125 may modify the result information 122 to generate the modified result information 126.

The method 400 also includes transmitting the modified result information to the computing device associated with the user, at 410. For example, in FIG. 1, the server may transmit the modified result information 126 to the computing device 110.

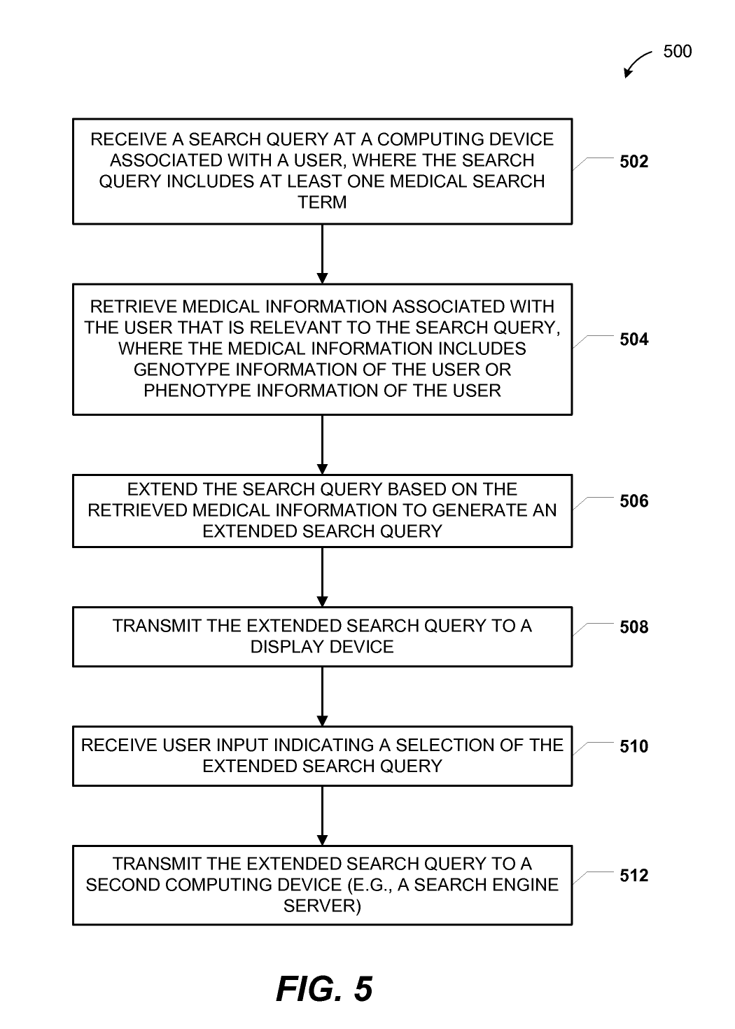

FIG. 5 is a flow diagram of another particular embodiment of a method 500 of content personalization based on user medical information. In an illustrative embodiment, the method 500 may be performed at the system 200 of FIG. 2.

The method 500 includes receiving a search query, at 502. The search query is received at a computing device associated with a user and includes at least one medical search term. For example, in FIG. 2, the computing device 210 may receive the search query 202 (e.g., including the medical search term “Asthma.”)

The method 500 also includes retrieving medical information associated with the user that is relevant to the search query, at 504. The medical information includes genotype information of the user or phenotype information of the user. For example, in FIG. 2, the relevant information identification module may retrieve the relevant medical information 214.

The method 500 further includes extending the search query based on the retrieved medical information to generate an extended search query, at 506. For example, in FIG. 2, the query extension module 211 may extend the search query 202 based on the relevant medical information 214 to generate the extended search query 215 (e.g., “Asthma+ADAM33”).

The method 500 includes transmitting the extended search query to a display device, at 508, and receiving user input indicating a selection of the extended search query, at 510. For example, in FIG. 2, the extended search query 201 may be displayed as a “suggested personalized search query” at the application 209 and the user 201 may select the extended search query 215 (e.g., via user input at a keyboard, mouse, or other input device).

The method 500 also includes transmitting the extended search query to a second computing device, such as a search engine server, at 512. For example, in FIG. 2, the computing device 210 may transmit the extended search query 215 to the server 220.

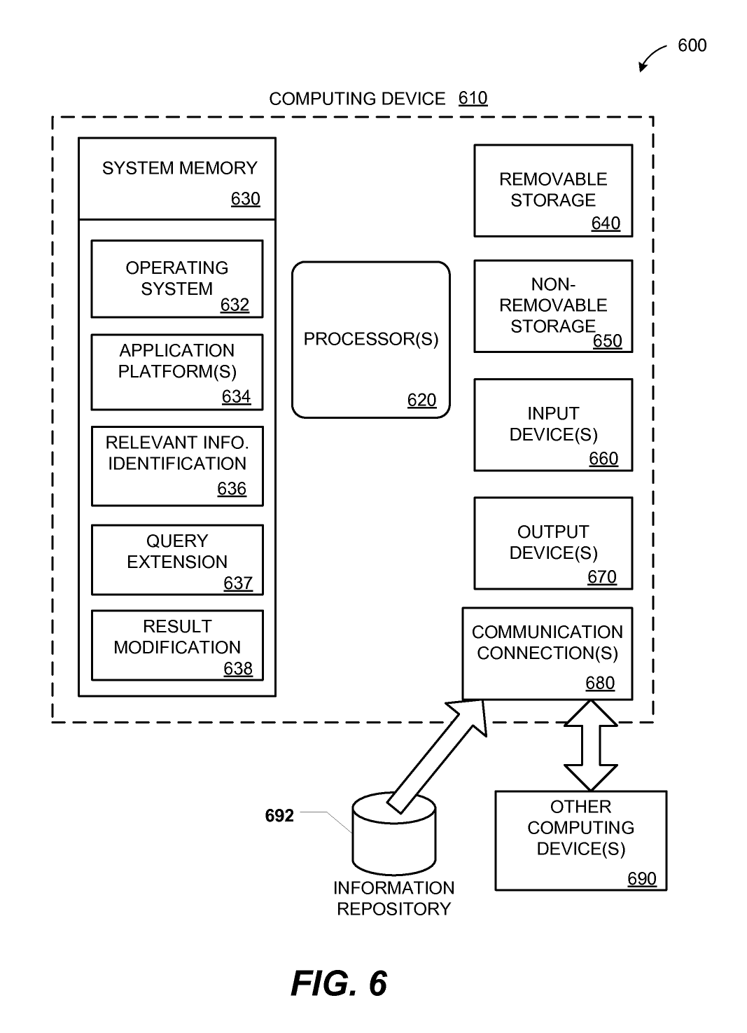

FIG. 6 shows a block diagram of a computing environment 600 including a computing device 610 operable to support embodiments of computer-implemented methods, computer program products, and system components according to the present disclosure. For example, the computing device 610 or components thereof may include, implement, or be included by the computing device 110 of FIG. 1, the server 120 of FIG. 1, the information repository 140 of FIG. 1, the computing device 210 of FIG. 2, the server 220 of FIG. 2, the information repository 230 of FIG. 2, the information repository 300 of FIG. 3, or portions thereof.

The computing device 610 includes at least one processor 620 and a system memory 630. Depending on the configuration and type of computing device, the system memory 630 may be volatile (such as random access memory or “RAM”), non-volatile (such as read-only memory or “ROM,” flash memory, and similar memory devices that maintain stored data even when power is not provided), some combination of the two, or some other memory. The system memory 630 typically includes an operating system 632, one or more application platforms 634, one or more applications, and program data. For example, the system memory 630 may include a relevant information identification module 636, a query extension module 637, and a result modification module 638. In an illustrative embodiment, the relevant information identification module 636 is the relevant information identification module 123 of FIG. 1 or the relevant information identification module 213 of FIG. 2. In another illustrative embodiment, the query extension module 637 is the query extension module 211 of FIG. 2. In another illustrative embodiment, the result modification module 638 is the result modification module 125 of FIG. 1.

The computing device 610 may also have additional features or functionality. For example, the computing device 610 may also include removable and/or non-removable additional data storage devices such as magnetic disks, optical disks, tape, and standard-sized or flash memory cards. Such additional storage is illustrated in FIG. 6 by removable storage 640 and non-removable storage 650. Computer storage media may include volatile and/or non-volatile storage and removable and/or non-removable media implemented in any technology for storage of information such as computer-readable instructions, data structures, program components or other data. The system memory 630, the removable storage 640 and the non-removable storage 650 are all examples of computer storage media. The computer storage media includes, but is not limited to, RAM, ROM, electrically erasable programmable read-only memory (EEPROM), flash memory or other memory technology, compact disks (CD), digital versatile disks (DVD) or other optical storage, magnetic cassettes, magnetic tape, magnetic disk storage or other magnetic storage devices, or any other medium that can be used to store information and that can be accessed by the computing device 610. Any such computer storage media may be part of the computing device 610.

The computing device 610 may also have input device(s) 660, such as a keyboard, mouse, pen, voice input device, touch input device, etc. connected via one or more input interfaces. Output device(s) 670, such as a display, speakers, printer, etc. may also be included and connected via one or more output interfaces. The computing device 610 also contains one or more communication connections 680 that allow the computing device 610 to communicate with other computing devices 690 over a wired or a wireless network. For example, the computing device 610 may communicate with an information repository 692. In an illustrative embodiment, the information repository 692 is the information repository 140 of FIG. 1, the information repository 230 of FIG. 2, or the information repository 300 of FIG. 3.

It will be appreciated that not all of the components or devices illustrated in FIG. 6 or otherwise described in the previous paragraphs are necessary to support embodiments as herein described. For example, the removable storage 640 may be optional.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Those of skill would further appreciate that the various illustrative logical blocks, configurations, modules, and process steps or instructions described in connection with the embodiments disclosed herein may be implemented as electronic hardware or computer software. Various illustrative components, blocks, configurations, modules, or steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method described in connection with the embodiments disclosed herein may be embodied directly in hardware, in a software module executed by a processor, or in a combination of the two. A software module may reside in computer readable media, such as random access memory (RAM), flash memory, read only memory (ROM), registers, a hard disk, a removable disk, a CD-ROM, or any other form of storage medium known in the art. An exemplary storage medium is coupled to a processor such that the processor can read information from, and write information to, the storage medium. In the alternative, the storage medium may be integral to the processor or the processor and the storage medium may reside as discrete components in a computing device or computer system.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The previous description of the embodiments is provided to enable a person skilled in the art to make or use the embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method, comprising:
receiving data representing an information retrieval task at a server from a computing device associated with a user;
executing the information retrieval task to generate result information;
retrieving personalization information associated with the user that is relevant to the information retrieval task, wherein the personalization information associated with the user includes information associated with at least one of a genotype of the user and a phenotype of the user;
modifying the result information based on the retrieved personalization information to generate personalized result information; and
transmitting the personalized result information to the computing device associated with the user.

2. The method of claim 1, wherein the data representing the information retrieval task is a user-initiated search engine query, wherein the server is associated with a search engine, and wherein executing the information retrieval task comprises querying the search engine based on the search engine query.

3. The method of claim 2, wherein the search engine query comprises at least one search term, the method further comprising retrieving data from an information repository based on the at least one search term.

4. The method of claim 3, wherein the information repository comprises a social networking source, a blog source, an electronic mail source, a computer-readable document source, a web site, a scientific paper repository, a publication repository, or any combination thereof.

5. The method of claim 3, wherein the personalization information is identified based on a match between the personalization information and the data retrieved from the information repository.

6. The method of claim 1, wherein the personalization information further comprises behavioral information associated with the user, physical condition information associated with the user, a medical history of the user, or any combination thereof.

7. The method of claim 1, wherein modifying the result information comprises filtering the result information based on the personalization information.

8. The method of claim 1, wherein modifying the result information comprises ordering the result information based on the personalization information.

9. The method of claim 1, wherein the result information comprises a plurality of items and wherein modifying the result information comprises highlighting one or more of the plurality of items that are determined to be relevant based on the personalization information.

10. The method of claim 1, wherein the personalization information associated with the user is retrieved from the computing device associated with the user.

11. The method of claim 1, wherein the personalization information associated with the user is retrieved from a second server remote to the server.

12. The method of claim 1, wherein the result information comprises textual information, video information, audio information, graphic information, or any combination thereof.

13. A computer-readable medium comprising instructions that, when executed by a computer, cause the computer to:
receive a search query at a computing device associated with a user;
retrieve medical information associated with the user that is relevant to the search query, wherein the medical information includes information associated with at least one of a genotype of the user and a phenotype of the user;
extend the search query based on the retrieved medical information to generate an extended search query; and
transmit the extended search query to a second computing device.

14. The computer-readable medium of claim 13, further comprising instructions that, when executed by the computer, cause the computer to receive search results that are based on the extended search query sent to the second computing device.

15. The computer-readable medium of claim 14, further comprising instructions that, when executed by the computer, cause the computer to transmit the received search results to a display device.

16. The computer-readable medium of claim 13, wherein the search query is received at an application executing at the computing device, wherein the application comprises a web browser, a social networking application, a library application, an archival application, or any combination thereof.

17. The computer-readable medium of claim 13, further comprising instructions that, when executed by the computer, cause the computer to transmit the extended search query to a display device.

18. The computer-readable medium of claim 17, further comprising instructions that, when executed by the computer, cause the computer to receive user input indicating a selection of the extended search query.

19. A computer system, comprising:
a processor;
a relevant information identification module executable by the processor to:
retrieve data from a medical information repository based on at least one medical search term of a search query; and
compare the data retrieved from the medical information repository to personal information associated with the user to identify medical information associated with the user that is relevant to the search query, wherein the medical information includes information associated with at least one of a genotype of the user and a phenotype of the user;
a query extension module executable by the processor to extend the search query based on the identified medical information to generate an extended search query; and
a result modification module executable by the processor to modify search results based on the identified medical information to generate modified search results.

20. The computer system of clam 19, further comprising an input interface executable by the processor to receive the search query and an output interface executable by the processor to transmit the modified search results to a display device.
